(19) United States
(12) Patent Application Publication
(10) Pub. No.: US 2014/0079265 A1
(43) Pub. Date: Mar. 20, 2014

(54) ELECTRONIC DEVICE WITH LOUDSPEAKER

(71) Applicant: HON HAI PRECISION INDUSTRY CO., LTD., New Taipei (TW)

(72) Inventor: KUO-HSIANG OUYANG, New Taipei (TW)

(73) Assignee: HON HAI PRECISION INDUSTRY CO., LTD., New Taipei (TW)

(21) Appl. No.: 13/707,602

(22) Filed: Dec. 7, 2012

(30) Foreign Application Priority Data
Sep. 20, 2012 (TW) 101134396

(51) Int. Cl. H04R 1/02

(52) U.S. Cl. CPC H04R 1/021
USPC 381/332

(57) ABSTRACT

An electronic device includes an upper shell, a bottom shell matched with the upper shell, a printed circuit board (PCB) and a loudspeaker module connected to the PCB. The loudspeaker module includes a loudspeaker and a flexible circuit board including two exposed metal pads electrically connected with the loudspeaker. The PCB includes two connecting pins contacting with the metal pads of the flexible circuit board to electronically connect the PCB to the loudspeaker.

### BACKGROUND

1. Technical Field

The present disclosure relates to electronic devices, and particular to an electronic device with a loudspeaker..

2. Description of Related Art

Electronic devices such as laptops, game players, and music players are equipped with loudspeakers for outputting sounds. The electronic device includes a circuit board, a loudspeaker, and cables for electrically connecting the loudspeaker to the circuit board. One end of the cable is welded on the circuit board. However, the process of welding is troublesome, and time consuming. Furthermore, it may weaken the signal transmitted from the circuit board to the loudspeaker, which causes bad outputted sounds.

Therefore, there is a need to provide an electronic device with a loudspeaker to alleviate the above mentioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an electronic device in accordance with an exemplary embodiment.

FIG. 2 is a partial, enlarged, exploded view of the electronic device of FIG. 1.

FIG. 3 is a further exploded view of the electronic device of FIG. 2.

FIG. 4 is similar to FIG. 3, but viewed from another perspective.

### DETAILED DESCRIPTION

The disclosure is illustrated by way of example and not by way of limitation in the figures of the accompanying drawings in which like references indicate similar elements. It should be noted that references to “a” or “one” embodiment in this disclosure are not necessarily to the same embodiment, and such references mean “at least one”.

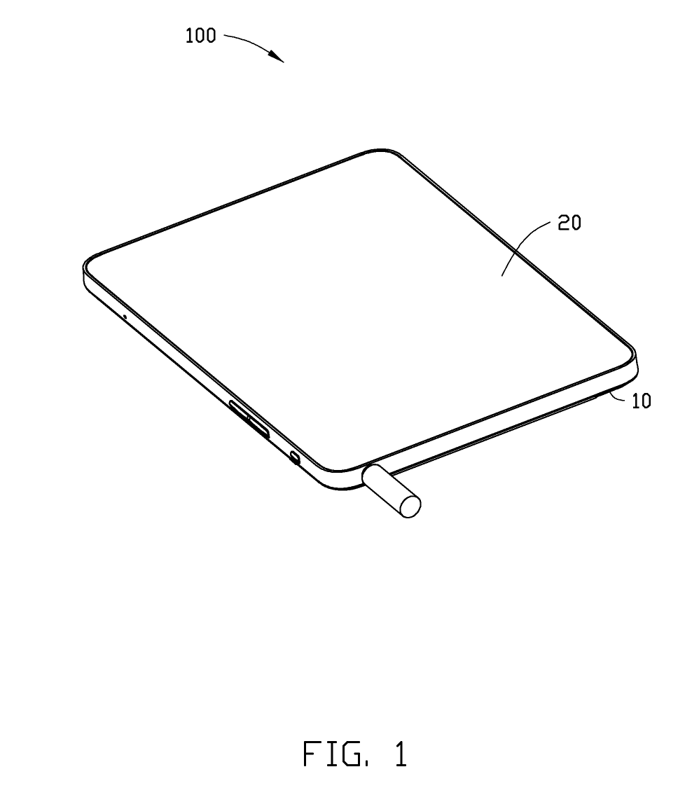

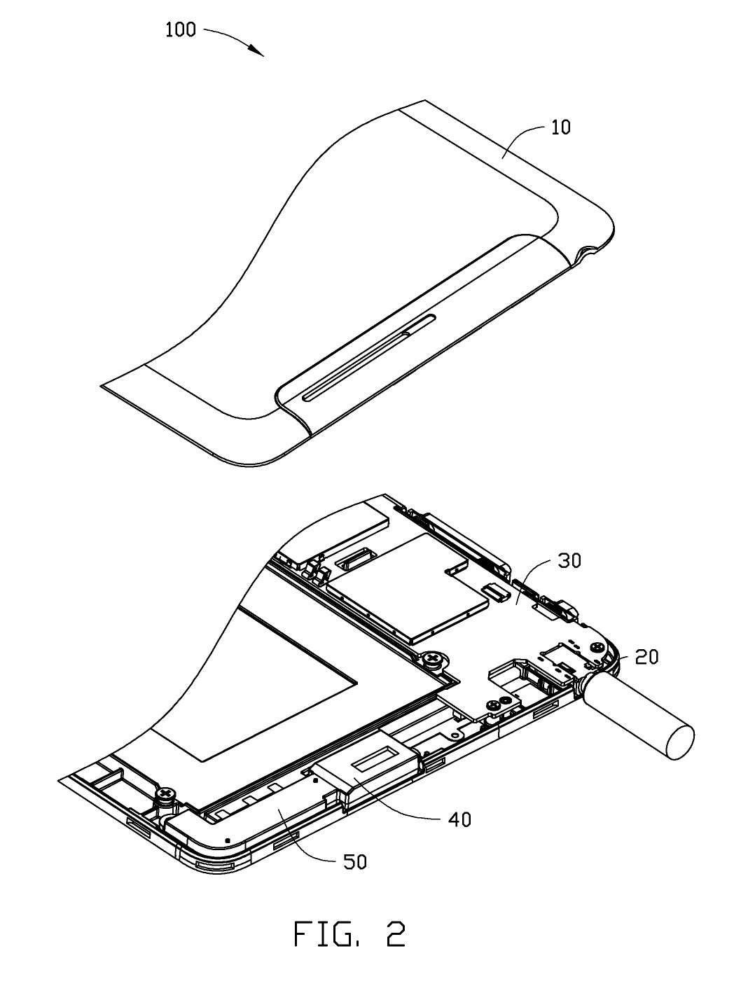

Referring to FIGS. 1-3, an exemplary electronic device 100 is provided. The electronic device 100 includes an upper shell 10 and a lower shell 20. The electronic device 100 may be a tablet PC, a mobile phone, or a personal digital assistant, etc. The electronic device 100 also includes a printed circuit board (PCB) 30, a loudspeaker module 40 and a mounting element 50. The loudspeaker mound 40 is mounted on the lower shell 20 and is adjacent to the PCB 30. The loudspeaker module 40 includes a loudspeaker 41 and a flexible circuit board 42 electronically connected with the loudspeaker 41. The loudspeaker 41 defines two receiving grooves 412 in two ends thereof. One receiving groove 412 faces the mounting element 50 and the other receiving groove 412 faces the flexible circuit board 42.

In the embodiment, the mounting element 50 is substantially L shaped. One end of the mounting element 50 is received in the receiving groove 412 facing the mounting element 50 for connecting the mounting element 50 to the loudspeaker 41. The other end of the mounting element 50 defines a through hole 51. The mounting element 50 is further security fasten to the lower shell 20 via screws (not shown) penetrating through the hole 51.

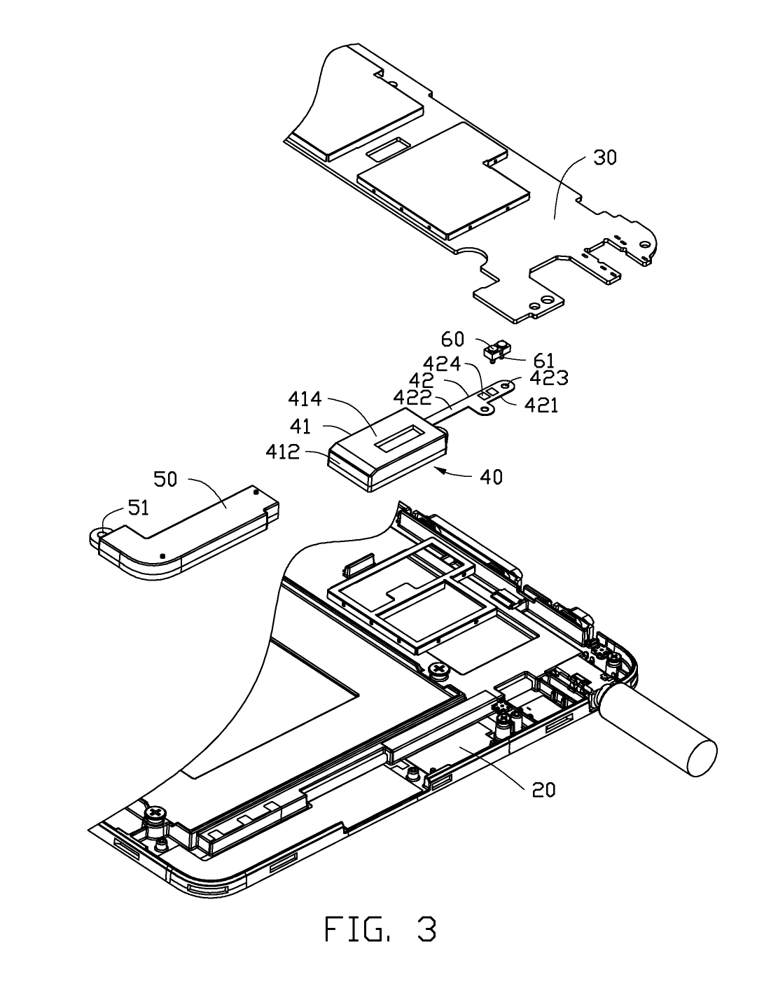

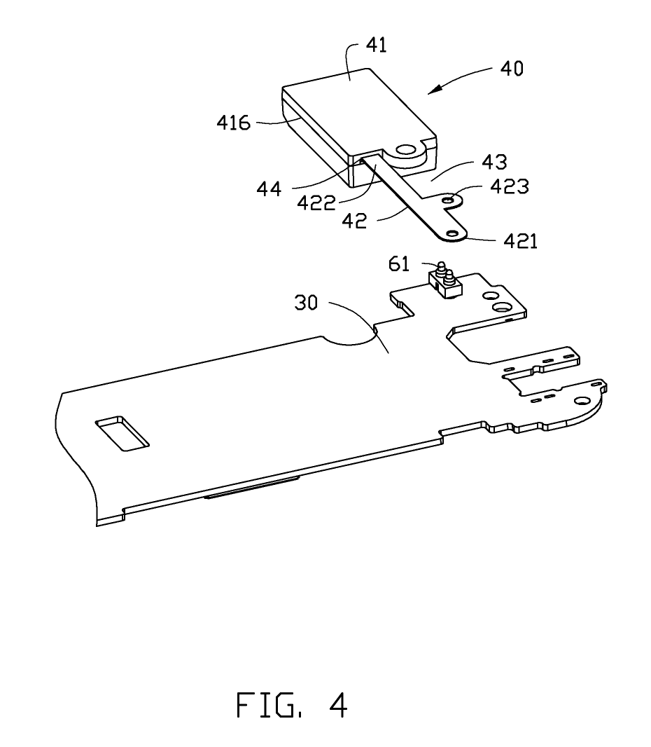

Referring to FIGS. 3 and 4, the loudspeaker 41 includes a voice output end 414 and a connecting end 416 opposite to the voice output end 414. The voice output end 414 is configured for emitting sounds, and the connecting end 416 is configured for electronically connecting the loudspeaker 41 to the flexible circuit board 42.

The flexible circuit board 42 defines a distal portion 421 and a connection portion 422 connected to the distal portion 421. The distal portion 421 defines a number of through holes 423 and two exposed metal pads 424. The flexible circuit board 42 is securely fasten to the lower shell 20 by screws (not shown) passed through the through holes 423, and the connecting portion 422 is received in the receiving groove 412 facing the flexible circuit board 42 for connecting the flexible circuit board 42 to the connecting face 416.

The PCB 30 is arranged between the upper shell 10 and the lower shell 20. A connector 60 is mounted on the PCB 30 and includes two connecting pins 61 located corresponding to the two exposed metal pads 424 of the flexible circuit board 42. The length of the connecting pin 61 is equal to the distance between the flexible circuit board 42 and the PCB 30. In the embodiment, the connecting pins 61 can be pin connectors.

With such a configuration, the PCB 30 connects with the connector 60, the connecting pins 61 connect with the metal pads 424 of the flexible circuit board 42 and the flexible circuit board 42 connect with the loudspeaker 41, thus the audio signals are transmitted from the PCB 30 to the loudspeaker 41 via the connecting pins 61 tightly connected to the metal pads 424 of the flexible circuit board 42. Therefore, the welding for connecting the cables and the PCB as the conventional way is avoided. Furthermore, compared to the way using the cables welded onto the PCB, the connecting pins 61 and the metal pads 424 of the flexible circuit board 42 have a larger size of connection area, thus the audio signals from the PCB 30 to the loudspeaker 41 are transmitted better because the better connection between the connecting pins 61 and the metal pads 424 of the flexible circuit board 42.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What claimed is:

1. An electronic device comprising:
an upper shell;
a lower shell;
a loudspeaker module mounted on the lower shell, the loudspeaker module comprising a loudspeaker and a flexible circuit board electrically connected with the loudspeaker, the flexible circuit board comprising two exposed metal pads; and
a printed circuit board (PCB) arranged between the upper shell and the lower shell,
a connector mounted on the PCB, the connector comprising two connecting pins electrically contacting the corresponding metal pads for electrically connecting the PCB to the loudspeaker.

2. The electronic device of claim 1, wherein the flexible circuit board comprises a distal portion and a connecting portion connected to the distal portion, the connecting portion is connected to the loudspeaker, and the metal pads are formed on the distal portion.

3. The electronic device of claim 2, wherein the distal portion is securely fastened to the lower shell.

4. The electronic device of claim 1, further comprising a mounting element configured for fastening the loudspeaker to the lower shell.

5. The electronic device of claim 4, wherein the mounting element is L-shaped, and one end of the mounting element is connected to the loudspeaker and the other end of the mounting element is securely fastened to the lower shell of the electronic device.
